(19) United States
(12) Patent Application Publication
(10) Pub. No.: US 2011/0068663 A1
(43) Pub. Date: Mar. 24, 2011

(54) SYSTEM FOR OPERATION OF ELECTRICALLY DRIVEN SHELVING

(76) Inventors: Brian Maurice Parker, Panorama (AU); George Giles Campbell, Brighton (AU)

(21) Appl. No.: 12/673,897

(22) PCT Filed: Aug. 18, 2008
(86) PCT No.: PCT/AU2008/001203

§ 371 Date: Feb. 17, 2010

(30) Foreign Application Priority Data
Aug. 17, 2007 (AU) 2007904423

(51) Int. Cl. A47B 53/00; H02K 7/116; H02P 7/00

(52) U.S. Cl. 312/201; 310/83; 318/139

(57) ABSTRACT

An electric drive mechanism for a body, wherein the body has a plurality of load bearing track engaging wheels that allow the body to move back and forth along a track. An electric motor drives a non-load bearing drive wheel that is attached with respect to the body so that it engages a stationary surface adjacent the body through a drive coupling means between the electric motor and the drive wheel. Actuation of the electric motor causes rotation of the drive wheel which moves the body along the track. Typically a first controller controls the movement of the body in one direction and a second controller controls the movement of the body in the other direction. Other features include a low power warning system, the inoperability of other motors when one is being operated and a disable facility if a motor has not been active for some time.

### CROSS REFERENCE TO RELATED APPLICATION

This application claims the benefit of priority of International Patent Application PCT/AU2008/001203, filed on Aug. 18, 2008, the entire disclosure of which is incorporated herein by reference.

### FIELD OF THE INVENTION

This invention relates to an electric drive mechanism for a track mounted body and in particular to an electric mechanism that can be installed new or retro-fitted to some current mechanical drive systems.

### BACKGROUND OF THE INVENTION

The present invention is adapted for use on track mounted shelving or cabinet units. Such shelving units are designed to provide compact storage by having the shelving units abut against one another with only one access opening being provided within which the shelves can be accessed. The shelves can be separated by moving them along the track to open up access at different points along the assembled shelves.

Most such shelving units are moved manually. There are however some that utilize manual crank mechanisms or electric drive means to move the shelves. This is more common when each shelving unit carries a heavy load.

Whether driven by a crank or an electric means the conventional means of providing a drive to each of the shelves is to connect the track mounted wheels to some form of drive means. This means that an axle extends across the base of each shelf to which the wheels are mounted. The shaft is then connected to some form of independent drive means which may be a manually rotated handle or an electric motor driven through a reduction gear box.

The need to mount a shaft within the base of the shelf unit results in added cost and complexity to the shelving unit. Accordingly the assignee of the present invention has previously developed a mechanically driven system that provides for a drive unit that drives the shelves by using a non-load bearing drive wheel and which is driven by a manually operable wheel mechanically coupled to the non-load bearing drive wheel.

However in some instances it is still desirable to have the shelving moved by an electric means. It is also desirable to be able to retro-fit existing shelving units having a manually operable system with an electric one with minimal modification required. It is further desirable to have system with a power source that can be easily replaced.

It is an object of the present invention to overcome at least some of the above-mentioned problems or provide the public with a useful alternative. It is also an object of the present invention to provide for a system that can be retro-fitted to some existing manually operable shelving units.

### SUMMARY OF THE INVENTION

In one form, the invention is an electric drive mechanism for a body, wherein the body has a plurality of load bearing track engaging wheels that allow the body to move back and forth along a track, the electric drive mechanism including an electric motor, a non-load bearing drive wheel that is attached with respect to the body so that it engages a stationary surface adjacent the body, a drive coupling means between the electric motor and the drive wheel wherein actuation of the electric motor causes rotation of the drive wheel which moves the body along the track, a battery adapted to provide power to the electric motor, and a controller that controls the operation of the electric motor to drive the body along the track.

In preference there may be two controllers, a first controller that causes the body to move along the track in one direction and a second controller that causes the body to move along the track in the opposite direction.

In preference the battery is easily removable to be able to be replaced when it needs to be recharged. Typically there could be some kind of indicia on the body to indicate to a user when the battery is running low on power and needs to be re-charged.

In preference there are multiple indicia that indicate the general state of the battery. For example, a first light can be used to indicate that the battery is at 50% power, a second light to indicate that the battery is at 25% power and a third light to indicate that the battery is at 10% power.

The electric drive mechanism described above avoids the need to have a drive axle mounted through the base of each body. In addition, it enables an electric motor to be attached to an existing body to convert it from a manually drivable unit to one that is electrically driven.

In preference the electric motor includes a reduction gear box. The drive wheel applies force to move the body by pushing against the surface on which the body is mounted. Preferably, the periphery of the drive wheel comprises a high friction material such as a polyurethane material and the surface against which the periphery of the drive wheel engages may also be roughened or have a high coefficient of friction to avoid slippage of the drive wheel.

Preferably, the drive coupling means between the electric motor and drive wheel includes reduction gearing. The reduction gearing can include many different types of components such as tooth belts, v-belts, meshing gear wheels and the like. One preferred arrangement is the use of a first belt that extends from the drive shaft towards the base of the body. This belt drives a first pulley wheel that in turn drives a second pulley wheel and there is a belt that extends from the second pulley wheel to a third pulley wheel that is attached to the drive wheel which in turn rotates the drive wheel.

In preference a timer mechanism is used wherein the electric drive mechanism turns from an active to a disabled mode if it has not been used for a pre-set period of time. A typical period of time is 2 minutes.

In preference once the motor is in the disabled mode it can only be turned to an active mode by operating both the first and the second controllers.

Preferably where there is a plurality of shelves each adapted to be driven by an electric drive mechanism all of the electric drive mechanisms are in communication with each other and wherein when any one shelf is being electrically operated, all of the other shelves are prevented from being operated.

In order to fully understand the invention, a preferred embodiment will be described. However, it should be realized that the invention is not necessarily restricted to the precise details of this embodiment. In particular, the preferred embodiment is described in relation to application of the invention to a shelving system. However, there may be other applications to which the invention could be equally suited.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention.

FIG. 1 illustrates three shelf units that are track mounted, two of the units being mechanically driven and the third being electrically driven.

FIG. 2 illustrates the electrical drive housing in more detail.

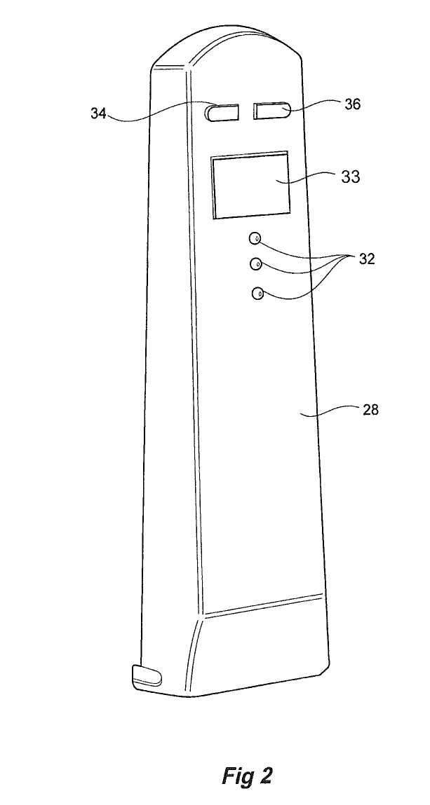

FIG. 3 illustrates a typical drive mechanism for the electrically driven unit.

FIG. 4 illustrates an operator using the electrically driven shelving.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts. Dimensions of certain of the parts shown in the drawings may have been modified and/or exaggerated for the purposes of clarity or illustration.

For the purposes of the specification the word “comprising” means “including but not limited to,” and the word “comprises” has a corresponding meaning. Also a reference within the specification to a document or to prior use is not to be taken as an admission that the disclosure therein constitutes common general knowledge.

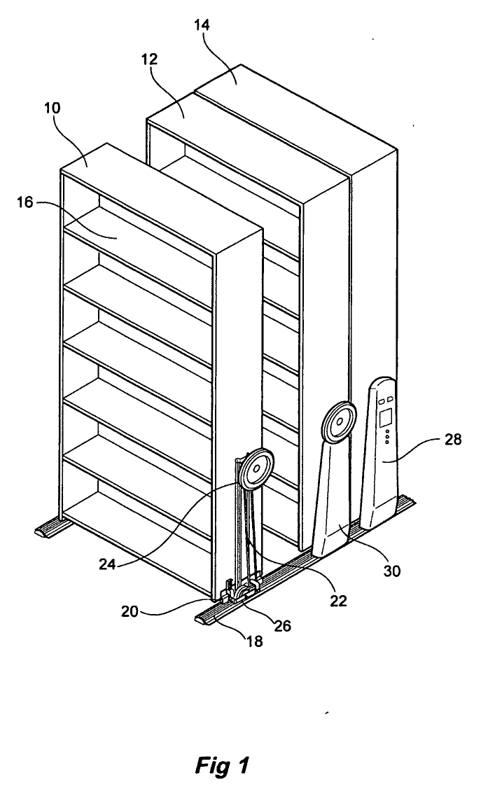

Referring to FIG. 1 there are three shelf units 10, 12, and 14 with shelves 16. The shelf units are mounted to tracks 18 via wheels 20. Tracks 18 provide a longitudinal recess within which the wheels 20 locate. A pair of wheels is used at each side of the shelf units and is rotatably mounted within a housing which is attached at each side of the units 10, 12 and 14.

In the case of three shelf units, typically the last shelf unit is fixed in position. However, in this embodiment and for illustrative purposes only we assume that all of the shelf units can move along the tracks.

The shelf units are moved along the tracks to provide access between various pairs of shelves. For example, shelf unit 10 can be moved so as to open up access between shelf unit 10 and shelf unit 12, and shelf unit 12 can be moved to provide access between shelf unit 12 and shelf unit 14.

Shelf units 10 and 12 have a mechanical actuator comprising a belt drive 22 and a hand operated wheel 24 that is rotatably mounted to the shelf unit. Using well know engineering principles the reader skilled in the art will appreciate that the belt drive 22 can be adapted in numerous ways to drive a non-load bearing drive wheel 26 that frictionally engages the track and enable operation of the wheel to move the shelf unit. To ensure that there is sufficient friction to engage the track the non-load bearing drive wheel 26 is biased towards the track, typically by use of a spring or the like.

Additional pulley arrangement may also be used that ensure that operation of the hand operated wheel 24 causes a pre-determined rate of movement of the shelf unit by using reduction gearing by the use of multiple wheels and pulley systems. For further details of this technology the reader is referred to International patent application PCT/AU2003/00360.

In the case of shelf unit 14 which includes an electric motor housed within housing 28, the reduction gearing may occur at the electric motor and no further belt pulley reduction gearing may be required, the belt drive 22 driving the non-load bearing drive wheel 26 directly.

It is envisaged that the hand operated wheel 24 and wheel housing 30 may be simply removed and replaced by housing 28 that includes an electric motor that engages the belt drive 22. Located at the front of the housing 28 is a battery 33 that may be simply removed by a fresh battery, the old one taken elsewhere for recharging. To assist an operator in determining when a battery needs recharging light indicia 32 may be used to indicate the state of the battery as is well known in the art. The lights turn on in succession warning of the battery power being low. Thus for example all three lights may be on when the battery power is less then 10%. Of course each light may only turn on itself and not all need to be on at the same time.

Located on the housing 28 are two control means, buttons 34 and 36. Operation of the left button 34 moves the shelving to the left, operation of the right button 36 moves the shelving to the right.

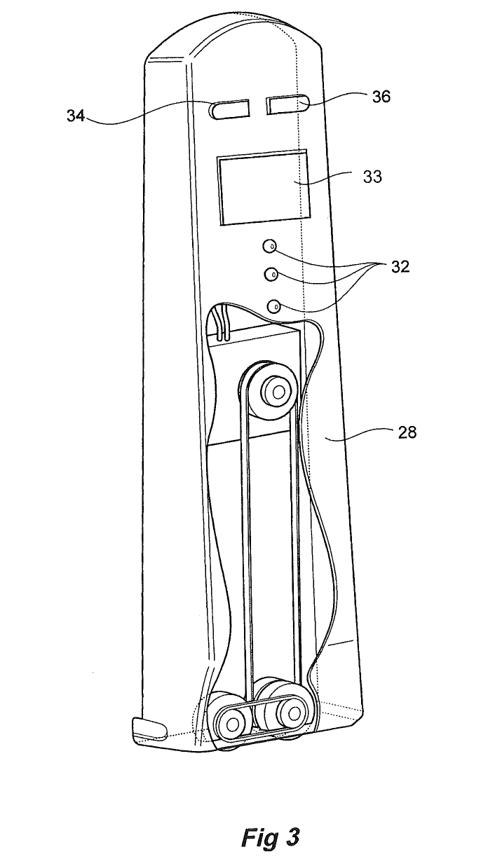

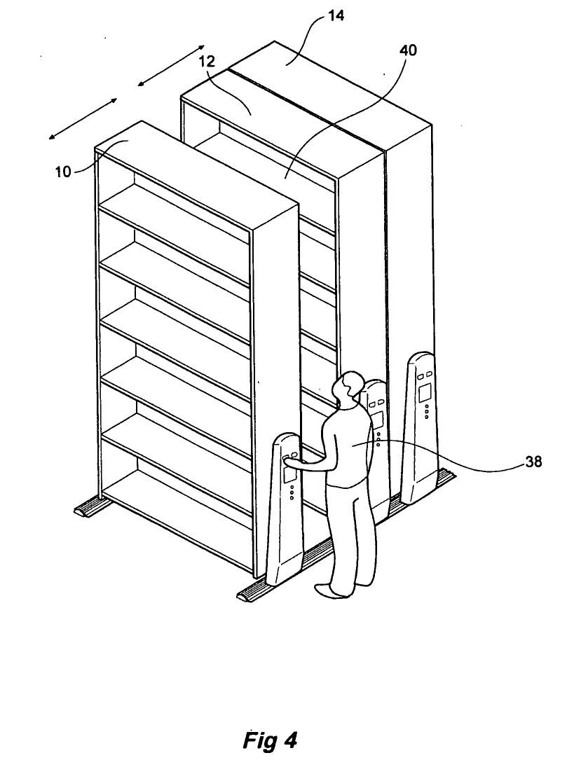

Thus as illustrated in FIG. 3 each of the shelf units includes an electrical driving means and each operable impendent of one another. However to ensure that equipment or persons are not injured it may be desirable to have various safety features installed into the operation of the shelf units as a whole. Thus, for example, and as illustrated in FIG. 4, an operator 38 who wants to move a shelf unit must first position himself or herself at the current opening 40. To power the shelf units on the operator must simultaneously activate opposing buttons on the adjacent electrical housing controllers, that is the right hand side button on the left hand side shelf unit and the left hand side button on the right hand side unit. By requiring both of the buttons to be activated the operator can not but see if the space between the shelf units is clear.

Once both such buttons have been activated and held for a pre-set period of time, such as one or two seconds, all of the units are then wirelessly powered up—that is—up until now either of the buttons 34 or 36 were disabled and only when this safety step has been undertaken are the buttons 34 and 36 able to operate the electric motor to make the shelf unit move.

Other safety feature may very well be incorporated such as once the buttons 34 or 36 are active enabling them to be active for only a pre-determined amount of time, or even deactivating all of the electric motors as soon as a shelf unit has indeed moved.

It will be clear from the above description that the invention provides a unique means of providing an electrical drive mechanism for track mounted bodies such as shelf units that can be installed on new systems or retro-fitted (docked) to existing mechanically hand operable shelf units.

Other improvements can be made to the currently proposed invention. Thus the shelf unit could have a separate activation button to be pressed by an operator once they have visually checked to ensure that there is no obstacle in the aisle. This activation is then beamed to all of the other shelf units drives using infra-red beams.

A beam could be used between all of the shelf units to force all of the drives into de-activation mode once the beam has been broken as would occur when a person would enter an aisle.

Each unit could also have an audio indicator, such as a chime, which will sound off until the movement of the shelf unit has been completed. All of the shelf units will also have receiving contacts that are connected to the electric motor.

Distance sending elements can also be employed to determine when a shelf unit has completely closed one aisle and opened another one.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

That which is claimed is:

1. An electric drive mechanism for a body, wherein said body has a plurality of load bearing track engaging wheels that allow said body to move back and forth along a track, the electric drive mechanism comprising:
an electric motor;
a non-load bearing drive wheel that is attached with respect to said body so that it engages a stationary surface adjacent said body;
a drive coupling means between said electric motor and said drive wheel wherein actuation of said electric motor causes rotation of said drive wheel which moves said body along, the track;
a battery adapted to provide power to the electric motor; and
a controller that controls the operation of said electric motor to drive said body along the track.

2. An electric drive mechanism for a body as in claim 1 including indicia to indicate when the battery needs to be recharged or replaced.

3. An electric drive mechanism for a body as in claim 2 wherein the indicia comprises multiple indicia that indicate a power state of the battery.

4. An electric drive mechanism for a body as claimed in claim 1 wherein the electric motor is coupled to the drive wheel through a reduction gearing means.

5. An electric drive mechanism for a body as claimed in claim 4 wherein the reduction gearing means includes a set of pulleys.

6. An electric drive mechanism for a body as claimed in claim 1 wherein the controller comprises two controllers for operating the electric motor to drive the body along the track, a first controller for driving the body in one direction and a second controller for driving the body in the other direction.

7. An electric drive mechanism for a body as claimed in claim 6 further including a timer mechanism wherein the electric drive mechanism turns from an active mode to a disabled mode if it has not been used for a pre-set period of time.

8. An electric drive mechanism for a body as claimed in claim 7 wherein the pre-set period of time is at least about 2 minutes.

9. An electric drive mechanism for a body as claimed in claim 7 wherein the electric drive mechanism turns from the disabled mode to the active mode by simultaneously operating both the first controller and the second controller.

10. An assembly of a plurality of shelves each adapted to be driven by an electric drive mechanism as defined in claim 1 wherein all of said electric drive mechanisms are in communication with each other and wherein when any one of said plurality of shelves is being electrically operated, all of the other of said plurality of shelves are prevented from being operated.
